(19) United States
(12) Patent Application Publication
(10) Pub. No.: US 2010/0075580 A1
(43) Pub. Date: Mar. 25, 2010

(54) SMALL CUTTING WHEEL

(75) Inventors: Heinrich Ostendarp, Haan (DE); Lutz Strehlow, Solingen (DE); Siegfried Piontek, Wuppertal (DE)

Correspondence Address: GREER, BURNS & CRAIN, 300 S WACKER DR, 25TH FLOOR, CHICAGO, IL, 60606, US

(73) Assignee: BOHLE AG, Haan (DE)

(21) Appl. No.: 12/234,328

(22) Filed: Sep. 19, 2008

(30) Foreign Application Priority Data
Sep. 19, 2008 (DE) 20 2007 013 306.5

(51) Int. Cl. B24B 7/00; C03B 33/12

(52) U.S. Cl. 451/259; 451/548; 30/164.95

(57) ABSTRACT

The invention relates to a small cutting wheel for producing a scribed/scored predetermined breaking line, wherein the cutting wheel has a radial peripheral line defining an outer periphery of the wheel which at least partially presents a cutting edge having cutting teeth which form a rough tooth system and which are circumferentially spaced from each other by intermediate tooth spaces. A cutting wheel shall be provided by which particularly flat displays but also other glass bodies can be produced with an improved quality of the separation planes and breaking edges and with minimum rejects also in different cases of application. For this purpose it is proposed that the cutting teeth of the rough tooth system include at least over a part of the perimeter of the small wheel a non-uniform arrangement in which the length Z of the cutting teeth and/or the length S of the intermediate tooth spaces varies at least between some adjacent teeth and/or intermediate tooth spaces or between all teeth and/or intermediate tooth spaces.

This invention relates to a small cutting wheel for producing a scribed predetermined breaking line on a body, wherein the cutting wheel has a radial peripheral line defining an outer periphery of the small wheel which at least partially presents a cutting edge having cutting teeth which form a rough tooth system and which are circumferentially spaced from each other by intermediate tooth spaces. The invention further relates to a cutting machine and to a manual cutter according to the claims 24 and 28.

Cutting wheels are known in a great variety and can be employed for instance for scribing/scoring most different glass bodies, for example glass plates, hollow bodies etc. These glass bodies can be different from each other concerning the nature of the glass, particularly its chemical composition and/or its surface finishing, the thickness of the material and so on. The requirements to the quality which is to be achieved for the separation planes and also the breaking edges of the respectively separated glass plates are very high for displays of electronic devices like monitors, mobile phones, CD cameras and so on. Here it is mostly required to produce a deep fissure by the scribing/scoring operation, which fissure extends over the entire thickness of the glass plate, so that rejects during the separation of the individual pieces of the glass plate can be minimized while simultaneously obtaining a high quality of the edges. By the scoring operation material tensions are introduced into the glass body, in order to produce a deep fissure, but on the other hand superficial chipping of the glass plate along its scoring line occurs. This too is undesired and can lead to an increased number of rejects. Although such chipping can be avoided by the cutting wheel being applied against the glass plate while exerting a low contacting pressure force, the result may be a small depth of the fissure, which fact in turn makes it more difficult to separate the pieces of the glass plate, and the number of rejects is also increased.

Accordingly, for separating pieces from glass plates for flat displays there have been partially employed laser cutting techniques which however require complex apparatuses. In addition, the productivity of such laser cutting processes is limited.

There are known small glass cutting wheels which are capable of producing such deep fissures and which are thus basically suitable for the manufacturing of flat displays like e.g. flat monitors. The documents EP 1 092 686 B1 and EP 773 194 B1 for instance describe cutting wheels in which a peripheral rib having alternating protrusions and recesses is formed by the converging inclined lateral surfaces. Here the recesses are respectively arranged at a predetermined interval. A drawback in these cutting wheels is however that the same do not in all cases of application achieve high quality separation planes and breaking edges by producing deep fissures, and it has to be taken into account here that glass plates which partially have very different thicknesses and/or material qualities are to be scored by means of one and the same cutting wheel. The glass quality can vary in a broad range concerning for instance the chemical composition of the glass and also the surface finish such as a surface hardening for instance. The thickness of the glass plates can vary from 0.4 to about 1.2 mm, i.e. by about the factor 3 or also clearly more, and the surfaces can also be hardened surfaces, surface finishes and so on. Further, the requirements are different depending on the type of the glass body that has to be processed, for instance flat glass, arced glass bodies and so on. However, the small glass cutting wheel shall always produce optimum separation planes and breaking edges, irrespective of the individual case of application. Small glass cutting wheels according to the documents EP 1 092 686 B1 or EP 773 194 B1 are not capable of this to the desired extent.

The invention is therefore based on the object of providing cutting wheels and in particular small glass cutting wheels, by means of which especially flat displays but also other glass bodies can be produced so as to have an improved quality of the separation planes and breaking edges even in different cases of application, while minimizing the rejects.

In accordance with the invention this problem is solved by a small glass cutting wheel as defined in claim 1 as well as a cutting machine according to claim 18 and a glass cutter according to claim 21.

In accordance with the invention the cutting wheels include at least over a part of their circumference a rough tooth system in a non-uniform arrangement referred to the length of the cutting teeth and/or the length of the intermediate tooth spaces in the circumferential extension of the wheel. The length of adjacent teeth and/or adjacent intermediate tooth spaces of at least a part or all of the teeth of the respective non-uniform tooth arrangement or of the entire wheel vary with respect to each other, so that the intermediate tooth spaces are no longer arranged at a predetermined interval.

Surprisingly it turned out that by means of the cutting wheels according to the invention the process latitude in processing is considerably increased; e.g. deep fissures can be produced also in the case of very different glass qualities and/or very different material thicknesses, so that with a given cutting wheel an almost optimum quality of separation planes and breaking edges can be obtained for a broad variety of different cases of application. This correspondingly applies also to a separation of glass bodies in a so-called “opened cut”, in which a certain separation of the separated parts of the body is effected already by the scoring operation. Without being bound by such theory, this can be attributed to the fact that vibrations are introduced into the glass body by the cutting teeth which result in tension peaks and finally in the formation of deep fissures. Due to the fact that the length of the cutting teeth and/or the intermediate tooth spaces is non-uniform and varies, the frequency spectral oscillation excitation is less limited to discrete frequencies. Thereby the coupling to the natural oscillation spectrum of the glass body can be better ensured. Due to the non-uniform or irregular length of the teeth and/or intermediate tooth spaces of the wheel according to the invention frequencies of a high dynamic yielding of the glass body are reliably met, which fact in turn reliably leads to big oscillation amplitudes and to deep fissures. Compared thereto, a regular tooth arrangement according to the document EP 1 092 868 B1 only generates a single base frequency and its harmonics, so that such an effect is not achieved and separation planes and breaking edges which meet the high quality requirements are produced only in special singular cases.

Although small glass cutting wheels are known which have an irregular fine or micro tooth system which is mostly produced by a grinding process, such micro tooth systems mainly only serve to reduce slippage of the cutting wheel over the glass plate during the scoring operation, but they are not capable of producing deep fissures of a sufficient depth. In addition, on the upper surface of the glass body they increasingly lead to lateral chipping and irregular breaking edges which are frequently not sufficient for today's requirements of flat displays.

A clear extension of the oscillation spectrum of the cutting wheel according to the invention can be noticed already when the teeth and/or tooth intermediate spaces are stochastically distributed over the circumference of the wheel.

The term “irregular” in the sense of the invention can be understood to particularly mean also a “stochastic” parameter like e.g. a stochastic sequence of distribution respectively.

A stochastic distribution in the sense of the invention is to be understood herein either to be a completely random distribution or also a distribution according to a probability function, e.g. a Gaussian distribution, so that certain ones of the randomly distributed parameters can occur with an increased probability. However, there is no mathematical-functional relation that follows definable laws.

Different teeth Z1, Z2 and/or intermediate tooth spaces S1, S2 having a different length can be respectively provided about the circumference of the wheel in a stochastically distributed fashion, wherein the respective other part can be constant or vary or also be stochastically distributed. In particular, also irregular tooth arrangements can be produced by that with an average tooth length Z′ and an average intermediate tooth space length S′, the teeth and/or intermediate tooth spaces respectively have a length within a predetermined interval Z′±d or S′±e and succeed each other irregularly. Here the offset of the teeth and/or intermediate tooth spaces can take place independently of the average position. But also in an irregular tooth arrangement for example, the teeth and/or intermediate tooth spaces having the average tooth length Z′ and/or the average intermediate tooth space length S′ can be arranged distributed around the central position, for example with a stochastic distribution, within a predetermined interval Z′±d and/or S′±e. Here the teeth and/or intermediate tooth spaces, which keep their average length, can be respectively arranged offset in one of the two circumferential directions by a stochastically varying amount within the interval. With cutting wheels which are designed in this way it is already possible to extend the application range of a wheel while simultaneously achieving optimum separation planes and breaking edges. In such wheels there is already generated a certain oscillation spectrum with a plurality of oscillations outside the base frequencies and their harmonics which are produced by a regular tooth arrangement, which fact is advantageous for many applications.

Concerning the length of the interval d, 2d≦Z′ or ≦9/10 Z′, 2d≦3/4 Z′, 2d≦1/2 Z′, 2d≦1/3 Z′ or 2d≦1/4 Z′ can apply. In a corresponding manner 2e≦S′ or ≦9/10 S′, 2e≦3/4 S′, 2e≦1/2 S′, 2e≦1/3 S′ or 2e≦1/4 S′ can apply. Concerning the intervals ±d and/or ±e it can generally independently apply that the same are larger than the deviations caused by manufacturing tolerances, for example ≧1-2%, ≧3-5% or ≧7% of the average tooth length Z′ or the average intermediate tooth space length S′ respectively. In particular, the intervals ±d and/or ±e can independently be ≧0.1-0.2 μm, ≧0.25-0.5 μm, ≧0.75-1 μm or ≧1.5-2 μm.

According to an alternative embodiment, in a given non-uniform tooth arrangement with an average tooth length Z′, teeth having tooth lengths of Z±n ΔZ can be provided, wherein n is an integer or a rational number smaller than 1. Here the teeth can be respectively offset from their middle position by the amount of ±n Δz in the circumferential direction of the wheel. Preferably one or two teeth which are adjacent to a given tooth have a tooth length different from that of the given tooth. This can apply to all teeth of a recurring tooth arrangement or to the entire wheel. Referred to adjacent teeth, the rational number n can be 3/4, 1/2, 1/3, 1/4 or 1/5, generally a ratio X/Y, wherein X and Y are respective integers smaller than 10.

By the fact that the tooth lengths Z can differ from each other by a multiple of an incremental tooth length difference ΔZ, it is possible in the scoring operation performed on the glass body to introduce oscillations in a fashion distributed over a spectrum, which oscillations also differ by incremental values Δν but on the other hand result in defined oscillations which are distributed in a certain spectral width, which fact turned out to be extremely favorable for the formation of deep fissures in the glass, because relatively sharp oscillation peaks can exist here too. All in all this turned out to be advantageous with regard to the quality to be obtained of the separation planes and partly also with regard to the applicable feeding speed of the cutting wheel during the scoring operation.

Concerning the intermediate tooth space length S of the tooth arrangement described in the preceding passages, Δs≦4 to 5 Δz or Δs≦2 to 3 Δz or Δs is approximately equal to Δz. Further, Δs≧0.75 to 1 Δz or Δs≧1.25 to 1.5 μz can apply. But the intermediate tooth space length can mainly be also constant, or for deviations of the intermediate tooth space length Δs from the average intermediate tooth space length S′, Δs≦S′ or Δs≦Δz can apply.

Alternatively or additionally to the above-described deviation of the tooth lengths Z from the average tooth length Z′, at an average intermediate space length S′ the intermediate tooth spaces can have lengths S of S′±m Δs, wherein m is an integer or rational number <1. That what has been mentioned above for n can analogously apply to m, and that what has been mentioned above for Δz can analogously apply to Δs (respectively referred to the parameter S or S′). Here the intermediate tooth spaces can be respectively displaced from their central position by the amount of ±m Δs in the circumferential direction of the wheel.

Concerning the tooth difference Δz, Δz≦Z′ or ≦9/10 Z′, preferably Δz≦3/4 Z′, Δz≦1/2 Z′, Δz≦1/3 Z′, Δz≦1/4 Z′ or Δz≦1/5 Z′ can apply in general. Correspondingly, concerning the deviation of the intermediate tooth length, Δs≦S′ or ≦9/10 Z′, preferably Δs≦3/4 S′, Δs≦1/2 S′, Δs≦1/3 S′, Δs≦1/4 S′ or Δs≦1/5 S′ can apply. Generally, the deviations Δz, Δs from the respective average value Z′, S′ are clearly larger than the manufacturing tolerances, for instance respectively independently from each other ≧0.1 to 0.2 μm, ≧0.25 to 0.5 μm, ≧0.75 to 1 μm or ≧1.5 to 2 μm. The deviations Δz, Δs can also be ≧1 to 2%, ≧3 to 5% or ≧7% of the average tooth length Z′ or the average intermediate tooth space length S′.

In a given non-uniform tooth arrangement which is preferably recurs several times around the circumference, the average intermediate tooth space length S′ can be larger/smaller than the average tooth length Z′; preferably the average intermediate tooth space length S′ is 1.1 to 5 or 1 to 3, preferably 1.2 to 2 or approximately 1.3 to 1.7 of the intermediate tooth length Z′.

The variation of the length of the teeth and/or the intermediate tooth spaces in the sequence of the rolling movement of the wheel can take place according to a mathematical-functional relation; it can take place periodically or aperiodically, if necessary also stochastically. In an aperiodical distribution a certain law of the succession of the teeth and/or intermediate tooth spaces can be provided, but certain interruptions can be given compared to a regular succession. The lengths of the teeth and/or intermediate tooth spaces can for instance continuously increase or decrease, e.g. in a linear or non-linear fashion, over the length of the tooth arrangement, e.g. comparable to a saw tooth function, but follow certain mathematical-functional laws. In a periodical succession of the teeth and/or intermediate tooth spaces compared to the average tooth length and/or intermediate tooth space length the variations along the periphery of the wheel can follow a periodical function like a sine or cosine function at least over a part of the wheel periphery.

The period length of the tooth succession and/or the succession of the intermediate tooth spaces can but needs not correspond to the length of the tooth succession respectively, it can also be smaller than the circumferential extension of the non-uniform tooth succession, for instance when the period length (normally measured as the number of teeth/intermediate tooth spaces or measured in units of length) of the teeth and the intermediate tooth spaces is different. It shall be understood that diverse superimpositions of the periods of teeth and intermediate tooth spaces are possible here. The period lengths of the teeth and intermediate tooth spaces can have a common divisor, so that the tooth succession will recur after a certain tooth sequence, but the divisor can also be rational or irrational. The oscillations which are introduced into the glass body during the scoring operation with such a tooth succession turned out to be particularly effective for the formation of deep fissures in the most different kinds of glass and thicknesses of glass. But it is also possible that the tooth length or the length of the intermediate tooth spaces changes periodically and the length of the respective other part changes aperiodically or stochastically. But it is also possible in particular that in a non-uniform tooth succession the length of the teeth changes in one of the above-described ways and that the intermediate tooth space length is constant over the given tooth succession. For certain applications small wheels may be useful in which the length of the intermediate tooth spaces changes in one of the above-described ways and the length of the teeth is practically constant or vice versa.

The entire tooth arrangement of the wheel preferably consists of a multiple repetition of one and the same given irregular tooth arrangement, but also two or more kinds of different non-uniform tooth arrangements can be repeated regularly or irregularly over the circumference of the wheel. The tooth arrangement which extends over the circumference of the wheel can mainly consist of two or more kinds of different non-uniform tooth arrangements which recur over the circumference of the wheel. If necessary, additional tooth arrangements Z2 or Zn can be provided between the recurring non-uniform tooth arrangements Z1, so that different kinds of tooth arrangements Z1, Z2 can recur one after the other in a defined or irregular succession, distributed over the circumference of the wheel. If necessary also stochastic, non-recurring arrangements can be provided between non-uniform tooth arrangements or also tooth arrangements which are uniform concerning the tooth lengths and the lengths of the intermediate tooth spaces. If necessary the recurring arrangements can also follow certain mathematical-functional laws. Accordingly, a small wheel can have provided thereon circumferential sections with stochastic arrangements between which non-stochastic tooth arrangements are provided. Thereby spatial frequency spectrums with certain frequency distributions can be introduced into the glass body, so that practically optimum results can be obtained here in various kinds of glass and in various thicknesses of glass.

The tooth arrangement, in particular the recurring tooth arrangement, can comprise over its length 2-20 teeth, up to 25-30 teeth or up to 40-50 teeth or even more , e.g. 4, 6, 8, 10, 12 or 16 teeth. The recurring tooth arrangement can also comprise ≧75-100 teeth, ≧40-50 teeth, ≧25-30 teeth or ≧15-20 teeth.

The non-uniform tooth arrangement can have a circumferential extension of ≧100-150 μm, ≧200-300 μm, ≧400-500 μm or ≧750-1000 μm, wherein the tooth arrangement can recur. The tooth arrangement can comprise at least two teeth. Preferably, the irregular tooth arrangement which can recur has a circumferential extension of ≦3.5-4 mm, particularly ≦2-3 mm or ≦1-1.5 mm, particularly ≦500-750 μm or ≦300-400 μm.

The cutting wheel can have a perimeter of ≧5-6 mm or ≧7-8 mm, particularly approx 9-10 mm. The perimeter of the cutting wheel can be ≦25-30 mm, ≦15-20 mm or ≦12-14 mm. The width of the cutting wheel, which can have a rotational axis, can be in a range of 0.3 to 5 mm, preferably in a range of 0.5 to 4 mm or in a range of 1 to 3 mm.

Referred to their base, the intermediate tooth spaces can be radially reawardly offset from the cutting edges of the teeth in a main plane by ≧0.5 to 1 μm, ≧1.5-2 μm, ≧3-4 μm or ≧5-10 μm, which corresponds to the tooth height. Further, the cutting edges of the intermediate tooth spaces can be radially rearwardly offset from the cutting edges of the teeth by ≦20-30 μm, ≦15-20 μm, ≦10-12 μm or also by ≦8 μm. The radial distance of the cutting edges of the intermediate tooth spaces from those of the teeth can be so dimensioned that during the scoring operation and with the intended force effect on the small glass cutting wheel the cutting edges of the intermediate tooth spaces grab into the glass plate, i.e. penetrate through its surface. The contacting pressure force which is exerted can be ≦10 N, particularly ≦5-7 N or ≦3-4 N, if necessary also ≦1-2 N. The contacting pressure force which is required can be dependent on the material of the glass body that is to be scored. Preferably the contacting pressure force is so selected that the deep fissure extends over the thickness of the glass body.

The cutting teeth can have a longitudinal extension in the circumferential direction of ≧2-5 μm, ≧10-15 μm or also ≧20-30 μm. The longitudinal extension of the teeth in the circumferential direction can be ≦200-300 μm, ≦75-100 μm or ≦40-50 μm. The longitudinal extension of the intermediate tooth spaces in the circumferential direction of the wheel can be ≧2-5 μm, ≧10-15 μm or ≧20-35 μm, preferably 20-40 μm. The longitudinal extension of the intermediate tooth spaces can be ≦200-300 μm, ≦100-150 μm, ≦50-75 μm.

The upper surfaces of the teeth and/or the lateral faces of the teeth can respectively have a roughening and/or a fine tooth system which can prevent slippage of the wheel over the surface of the glass plate during the scoring operation. The roughening can be effected for instance by suitable grinding means. The height of the texture of the roughening or fine tooth system can be clearly smaller than the tooth height, for instance ≦¼, ≦⅛ or ≦ 1/16 of the same. The surface roughness Rz according to DIN/ISO 4287 can be ≦4.5-5 μm or ≦3.5-4 μm or also ≦2.5-3 μm, for instance in the range of 0.5 to 5 μm, preferably 0.75 to 2 μm. The roughness Ra according to DIN/ISO 4287 can be ≦0.4-0.5 μm, e.g. in the range of 0.05-0.5 μm or 0.1-0.4 μm, preferably in the range of 0.1-0.3 μm. The fine tooth system can be regular or irregular and in the form of tooth ribs which can converge towards the cutting edge or at least extend with one direction component towards the cutting edge or be in the form of isolated, substantially punctiform elevations or the like. If necessary, also the intermediate tooth spaces can have a roughening and/or fine texture, to which applies what has been mentioned above and which is at most slightly spaced from the cutting edge of the intermediate tooth spaces, so that the fine texture will interact with the glass plate to be scored when the cutting wheel is employed in the usual way.

The cutting wheel can consist of a polycrystalline diamond or a sintered metal material that is preferably provided with a surface coating which may have wear-reducing properties.

The cutting wheel can normally comprise all types of cutting teeth or two or more types of intermediate tooth spaces which can be different from each other by their width, cross sectional shape or in any other way. But for the most applications it is sufficient for the wheel to comprise only one type of cutting teeth and only one type of intermediate tooth spaces which differ only in their circumferential extension.

In addition to the rough tooth system the cutting wheel can have a fine tooth system that can be produced particularly by a grinding operation. This fine tooth system can be provided on the tooth backs of the cutting teeth or on different suitable locations and it can additionally prevent wheel slippage or wheel spin during the scoring operation in which the wheel is required to perform a rolling movement against the surface of the glass body to be scored. The height of the texture or fine tooth system can be clearly smaller than the tooth height, for instance ≦¼, ≦⅛ or ≦ 1/16 of the same. The surface roughness Rz according to DIN/ISO 4287 can be ≦4.5-5 μm or ≦3.5-4 μm or also 2.5-3 μm, e.g. be in a range of 0.5 to 5 μm, preferably 0.75 to 2 μm. The roughness Ra according to DIN/ISO 4287 can be ≦0.4-0.5 μm, e.g. be in a range of 0.05-0.5 μm or 0.1-0.4 μm, preferably in a range of 0.1-0.3 μm. The fine tooth system can be regular or irregular and in the form of tooth ribs which can converge towards the cutting edge or extend with at least one direction component towards the cutting edge, in the form of isolated, mainly punctiform elevations or the like.

Further, a parameter can be provided which is superimposed to a mathematical-functional relation between the arrangement of the teeth and/or the intermediate tooth spaces of a given recurring arrangement of teeth, so that the tooth arrangement is altogether stochastically or irregularly distributed. If for instance the teeth and/or the intermediate tooth spaces of the tooth succession are extended by an amount of +Δz and/or +m Δs compared to the tooth/intermediate tooth space preceding in the direction of the rolling movement, the arrangement of the teeth/intermediate tooth spaces can vary over the tooth perimeter corresponding to V*n Δz or V*m Δs, wherein V can be +1 or −1 if distributed irregularly or statistically. If the arrangement of the teeth/intermediate tooth spaces is not symmetrical to the center of the respective tooth arrangement, this can respectively result in a different effective tooth succession with respect to the given roll-off direction of the wheel. It shall be understood that this statistically or irregularly selected factor V can be present also with respect to others of the above-described parameters of the arrangement of the teeth/intermediate tooth spaces. If necessary a scaling factor which varies in a certain range can be provided and can be statistically selected from a predetermined range, so that successive tooth arrangements are varied by the given statistic scaling.

Thus the wheel can be normally designed in such a way that a non-regular tooth arrangement as a basic arrangement recurs several times over the perimeter of the wheel in the form of modifications, wherein these modifications are the result of the influence of at least one variation parameter on the parameters of the basic arrangement which define the tooth arrangement. The variation parameter between the different tooth arrangements can vary non-uniformly or irregularly.

Generally, the tooth succession within a tooth arrangement can be such that starting from an intermediate tooth space which is in its middle position (the center of this intermediate tooth space thus practically coinciding with the middle position of the same) [?] is positioned on a tooth back. The distance of this tooth (referred to its tooth center) from the center of the first intermediate tooth space accordingly is n*S′, wherein n is an integer. This can be the case for instance in periodically changing tooth lengths Z and/or intermediate tooth space lengths s and sufficiently long tooth arrangements.

Further, within a tooth arrangement which can recur at least one or several times over the perimeter of the wheel, the length of the teeth Z and/or of the intermediate tooth spaces S can generally vary.

Further, it can generally apply that for some or all intermediate tooth spaces of the tooth arrangement, particularly of a recurring tooth arrangement, the length of the teeth and the intermediate tooth spaces is so dimensioned that in the rolling movement of the wheel against a planar surface, after the first tooth which contacts the surface, a second tooth will engage the surface before the surface is contacted by an intermediate tooth space.

Finally, compared to conventional wheels, wheels which have been manufactured in accordance with the invention turned out to be advantageous also in the making of shape-cut lines. In a shape-cut the cutting or scoring line is not linear, but for example arc-shaped. The wheels which have been manufactured in accordance with the invention are capable of particularly easily and exactly following the desired shape also in the case of narrow curvature radii. Further, the wheels can be advantageously employed in the closed shape-cut (i.e. in the case of a closed-shape line, e.g. an arc of a circle), since the contoured body can be more easily and accurately separated from the surrounding material.

The invention further relates to a cutting machine with a table for supporting a glass plate to be scored in accordance with the features of the generic part of claim 18, wherein a small cutting wheel according to the invention is mounted to the cutting head. Correspondingly, the invention also relates to a method of scoring glass bodies, in particular glass plates, by means of a small cutting wheel according to the invention and to method of producing glass bodies, in particular glass plates, which are obtained from a larger body by making predetermined breaking lines with the aid of a small cutting wheel and by separating the glass body along these lines.

The length of the rolling movement of the irregular tooth arrangement of the cutting wheel can recur two or more times around the perimeter of the wheel and can be particularly within the range of or smaller than the material thickness of the glass body to be scored or be ≦¾, ≦½, ≦⅓, ≦¼ of the thickness of the glass body. The distance of the rolling movement of the non-uniform tooth arrangement can be ≧100 μm. Thus the oscillations which are introduced by the tooth arrangement into the glass body can recur several times over the perimeter of the rolling movement of the wheel, so that a very effective formation of deep fissures in closely succeeding zones of the glass plate is achieved, so that all in all excellent separation planes and breaking edges can be produced. The thickness of the glass plate or of the glass body in general in the zone which has to be separated can be larger than ≧0.1-0.2 mm, ≧0.3-0.4 mm. On the other hand, the thickness of the glass plate can be ≦4-5 mm, ≦3-3.5 mm, particularly ≦2.5-2.75 mm, ≦2-2.5 mm, if necessary also ≦1.75-1.9 mm.

In the following the invention will be described by way of embodiments. It is shown by:

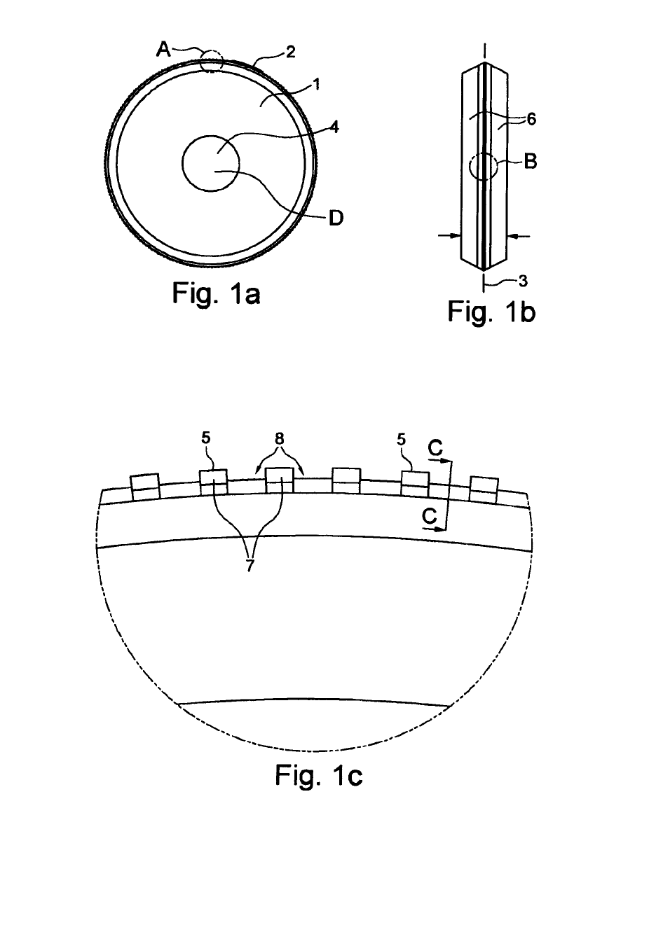

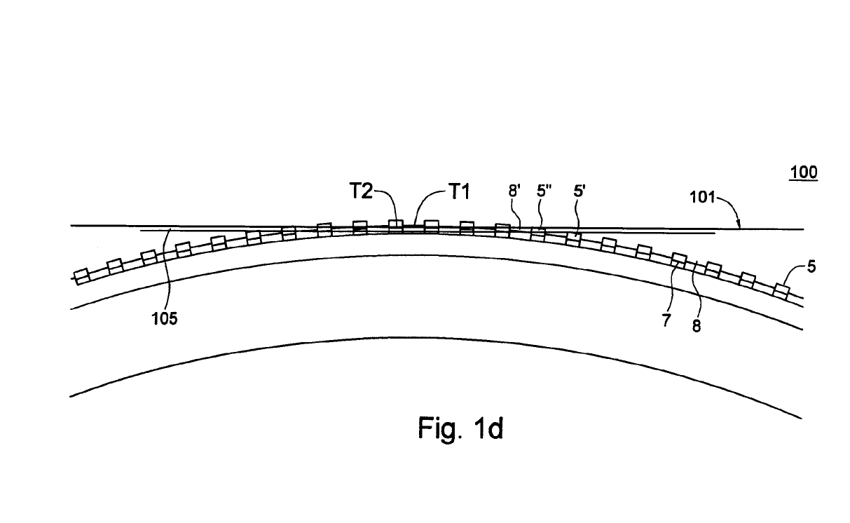

FIG. 1 a small cutting wheel in a lateral view (FIG. 1a), in a frontal view (FIG. 1b), in a detailed view (FIG. 1c) and in a detailed view during the scoring operation (FIG. 1d);

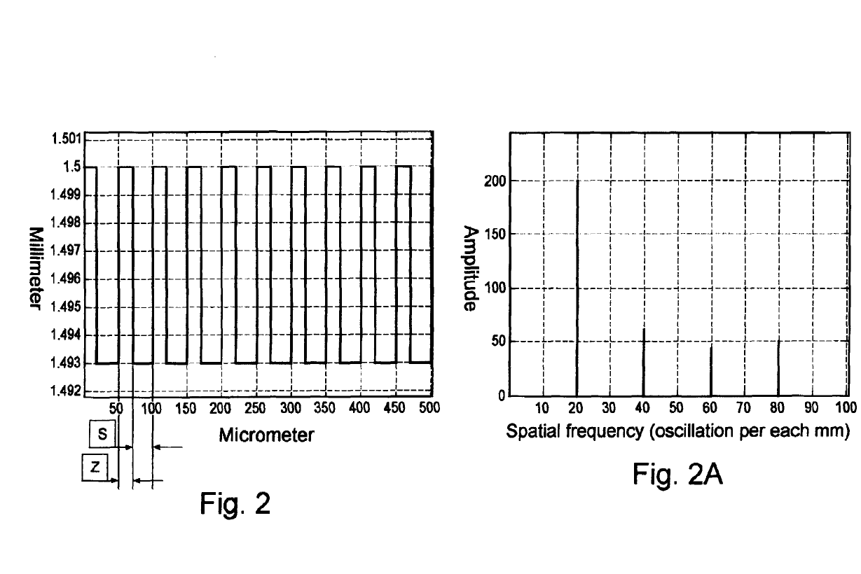

FIG. 2 a detail of the tooth succession of the wheel in a schematic representation, with a regular arrangement (not in accordance with the invention);

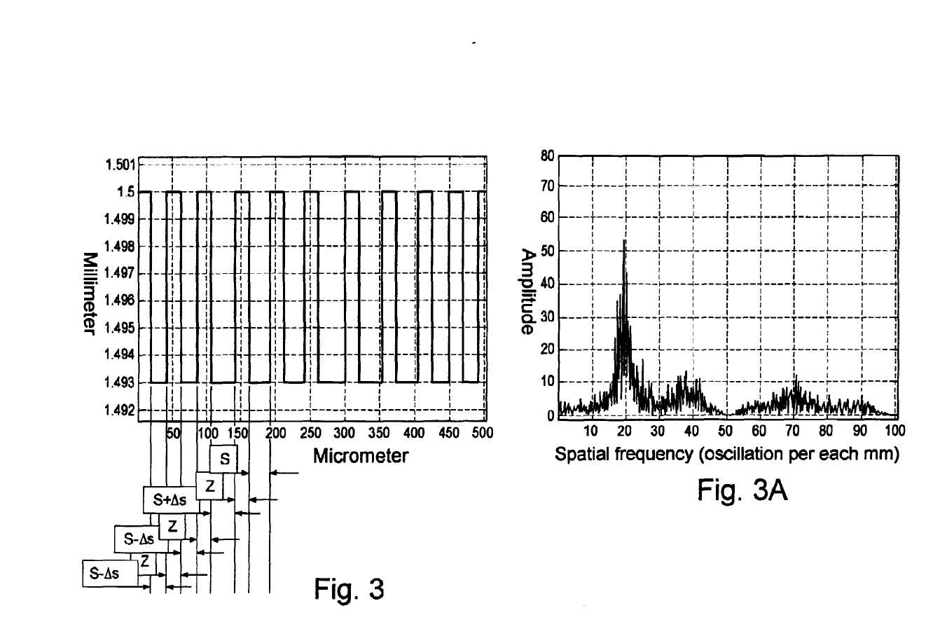

FIG. 3 a schematic representation of the tooth arrangement having intermediate tooth space lengths S±ΔS, with a stochastic distribution;

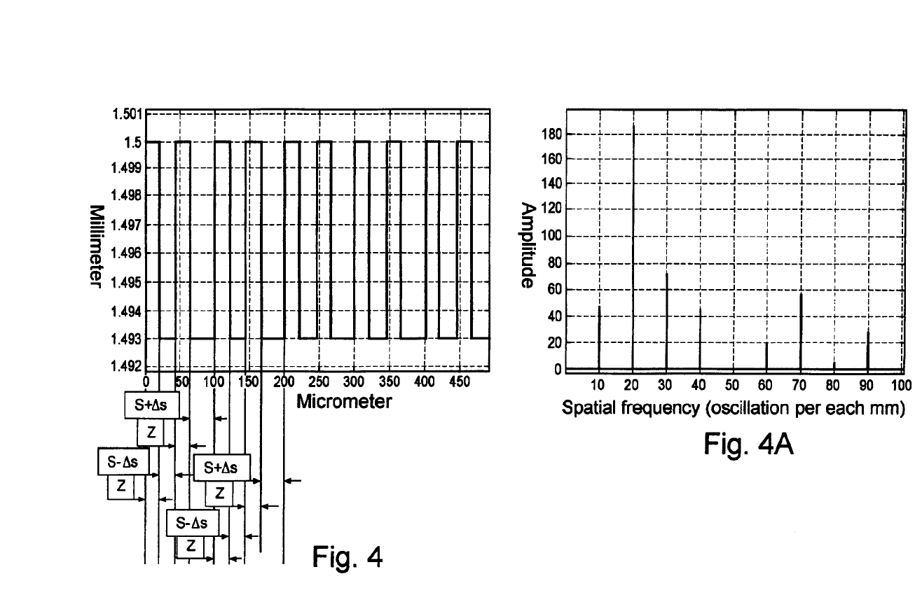

FIG. 4 a tooth arrangement with a varying intermediate tooth space length;

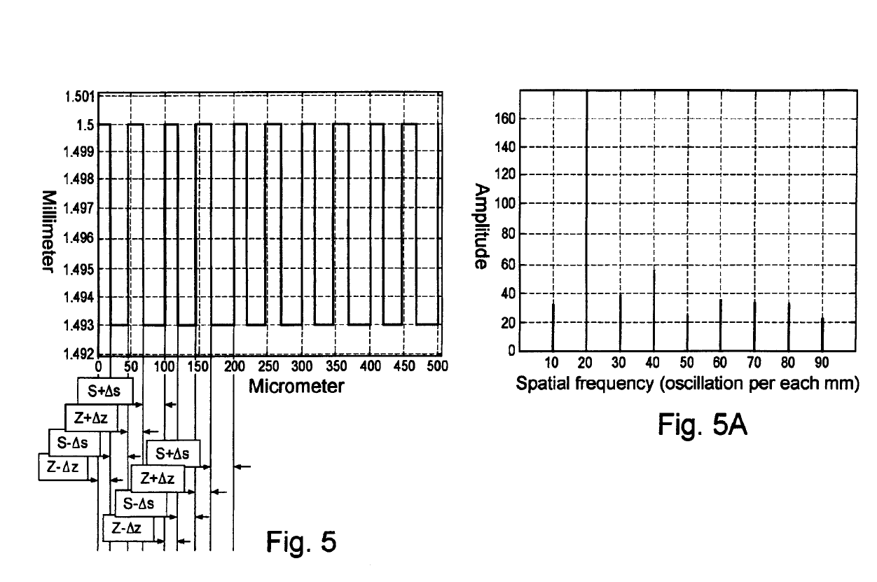

FIGS. 5-9 different tooth arrangements with varying tooth lengths and intermediate tooth space lengths;

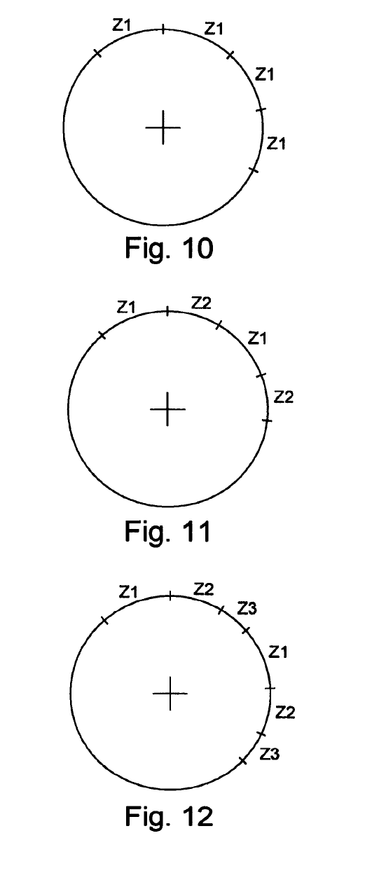

FIGS. 10-12 schematic representations of small cutting wheels with different arrangements of tooth successions;

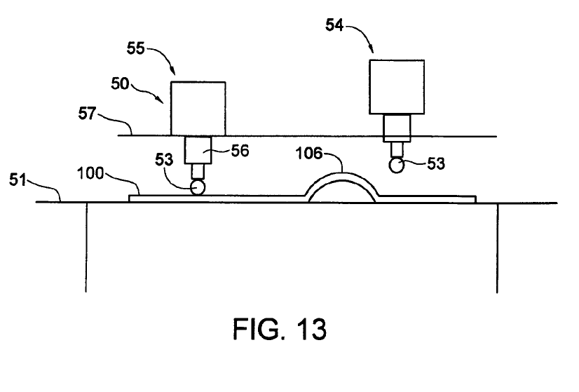

FIG. 13 a cutting machine equipped with the small wheel according to the invention.

For the purpose of explanation, FIG. 1 shows in a schematic representation a small glass cutting wheel 1 for making a scored predetermined breaking line on a glass plate having a radial peripheral line 2 defining the outer periphery of the wheel and being in a main center plane 3 which is perpendicular to the axis of rotation D of the cutting wheel. In the center of the wheel a recess 4 is provided for inserting a shaft. The small wheel can have an outer diameter of approximately 3 mm, a width of approximately 0.6 mm and a perimeter of approximately 9.4 mm. The wheel has lateral surfaces 6 which are inclined and which converge towards the main center plane 3 and can intersect in this plane. The peripheral line 2 presents a plurality of cutting teeth 7 with cutting edges 5 lying on the peripheral line and being circumferentially spaced from each other by intermediate tooth spaces 8. For the purpose of explanation, the lengths of the teeth 7 and the intermediate tooth spaces are respectively the same size in the illustration of FIG. 1, so that this arrangement is not in accordance with the invention. The wheel can consist of a preferably wear-coated sintered metal material or of a polycrystalline diamond. The tooth upper surfaces of the wheel can be roughened, for instance by a grinding operation, wherein the radial height of the cutting teeth exceeds a possible random surface roughness. The surface roughness (according to DIN/ISO) can be 1.5 μm, the roughness Ra approximately 0.15 μm. If necessary the tooth upper surface can also be polished. As it is further illustrated in FIG. 1d, the length of the teeth and the intermediate tooth spaces can be so dimensioned that when the wheel rolls off against a planar surface 101 of the glass body 100, after the first tooth 5′ contacting the surface, the surfaces is contacted by a second tooth 5″, before an intermediate tooth space 8′ will come into contact with the surface.

FIG. 2 (left) shows in a schematic representation a tooth arrangement comprising teeth having a constant tooth length Z and intermediate tooth spaces having a constant length S. Here the arrangement of the teeth and the intermediate tooth spaces is shown along the line illustrated on the axis X of the rolling movement of the wheel over its outer peripheral line 2. Here the tooth length Z amounts to 20 μm, the intermediate tooth space length S amounts to 30 μm, the ratio of the intermediate tooth space length S to the tooth length accordingly being 1.5.

FIG. 2 (right) shows a spatial frequency spectrum in the way of an amplitude density spectrum which is the result of a Fourier transformation of the tooth structure according to FIG. 2 (to the left) introducing the oscillations into the glass body, wherein it is assumed that at the time of penetration of the respective tooth into the surface of the glass body a corresponding force is exerted on the same. A multiplication of the spatial frequency illustrated in FIG. 2 (right) by the displacement speed (m/sec) of the wheel over the surface of the glass will produce the oscillation frequencies which are introduced into the wheel at the location at which the wheel is applied. Here and also in the other representations the amplitude is shown as a randomly normalized amplitude. The spectrum according to FIG. 2 (right) can be understood by the occurrence of a base frequency at 20 oscillations per each mm (corresponding to the sum of the lengths of a tooth and the intermediate tooth space of 50 μm) and their harmonics. The structure/texture of the tooth arrangement which is shown in FIG. 2 (left) corresponds to one which is disclosed in the documents EP 773 194 or 1 092 686 B1.

FIG. 3 shows a stochastically structured/textured tooth arrangement in which the teeth have a constant tooth length Z (here 20 μm) and in which the intermediate tooth space length S respectively decreases or increases by a defined amount Δs around the average length S′ or assumes that average length S′. The algebraic sign of the variation of length Δs here varies stochastically, hence completely randomly. In average, the tooth arrangement thus shows a recurring length (tooth length+intermediate tooth space length), also referred to as “pitch”, of 50 μm.

According to FIG. 3b the resulting spatial frequency spectrum (power density spectrum) is one having a continuous frequency distribution, wherein a spatial frequency of 20 oscillations per each mm produces a peak of a certain width. Hence, oscillations are generated even below and above 20 oscillations per each mm, without increases which occur only at individual frequencies. Here relatively high amplitudes are introduced into the glass body over relatively large frequency ranges. This situation is fundamentally different from the spatial frequency spectrum according to FIG. 2 (right) with a small number of very sharp peaks at certain defined spatial frequencies. In particular, in the wheel according to FIG. 3 spatial frequencies of a relatively high amplitude are generated at spatial frequencies which can clearly deviate from an integer multiple of the base frequency. Further, with spatial frequencies <10 oscillations per each mm (correspondingly taking into account the displacement speed also for the oscillations introduced into the glass body per each second) practically no frequencies having significant amplitudes are generated. A significant difference has to be seen herein compared to previously known cutting wheels having an irregular micro tooth system which can be produced for instance by a grinding operation, in order to avoid wheel slip.

FIG. 4 (left) shows a further variant of the small wheel according to the invention, wherein the teeth respectively have a constant tooth length Z (here 20 μm) and the intermediate tooth space length S of respectively adjacent intermediate tooth spaces is smaller or larger than the average intermediate tooth space length S′ by a defined amount Δs (here 6 μm, i.e. ±20% deviation from the average value). This results in a non-uniform or irregular tooth arrangement comprising two teeth which accordingly recurs after each third tooth. The length of the recurring tooth arrangement is 100 μm. Hence the tooth arrangement includes alternating short and long intermediate tooth spaces.

According to a spatial frequency spectrum as illustrated in FIG. 4 (right) such a variation of the intermediate tooth spaces in accordance with the structure illustrated in FIG. 2 results in that in the vicinity around the main peak, at number of 20 oscillations per each mm, additional peaks are formed having a considerable amplitude, in the present case at 10 and 30 oscillations per each mm. Further, at spatial frequencies at which practically no oscillations are generated with a uniform structuring/texturing, oscillations having a considerable amplitude are generated, as for instance at 70 and 90 oscillations per each mm. Also with this variant of the structure/texture, in which a comparatively simple variation of the intermediate tooth space length S takes place, a spatial frequency spectrum is obtained having a considerably broader frequency distribution, and particularly additional high amplitude oscillations around the main peak are generated. This turned out to be particularly advantageous for the formation of deep fissures and optimum separation planes and breaking edges. Thus oscillations which differently from a regular structuring/texturing lead to the formation of deep fissures can be introduced into the glass body even at short lengths of the rolling movement of the wheel.

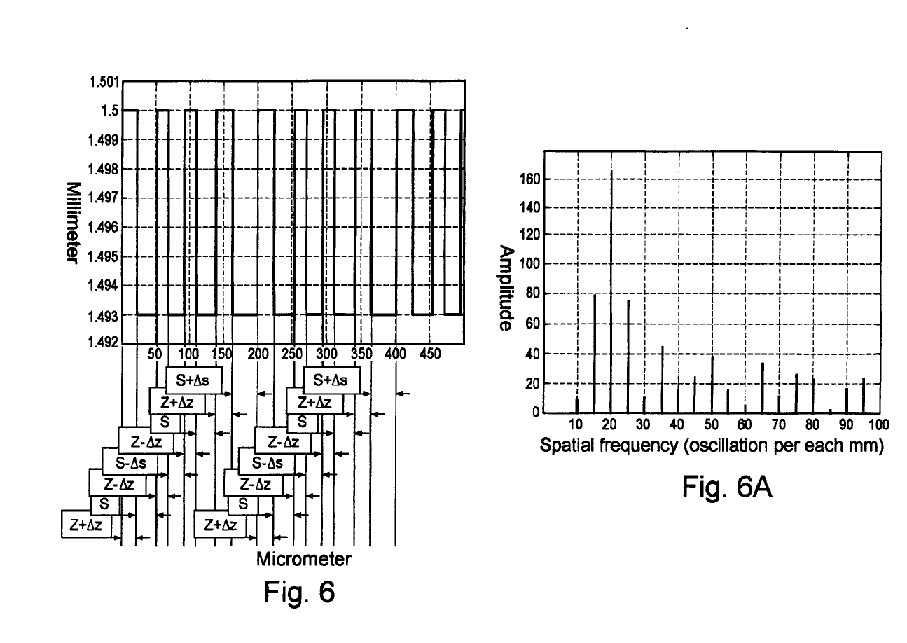

FIG. 6 (left) shows a tooth arrangement according to the invention with teeth and intermediate tooth spaces of an average length Z′, S′, wherein the successive teeth are respectively alternatingly shortened or lengthened compared to the average tooth length Z′ by a same amount and thus have the length Z′−Δz or Z′+Δz. Here the tooth length is 20 μm, the deviation Δz 2 μm, hence a fluctuation around the average value is ±10%. This correspondingly applies to the intermediate tooth spaces S which are respectively alternatingly shortened or lengthened compared to the average value S (30 μm) by the same amount Δs (3 μm), so that in this case, too the fluctuation around the average value is ±10%. Also in this case the result is a recurring tooth arrangement which comprises two teeth and which has a length of 100 μm.

According to FIG. 5 (right) the result is a spatial frequency spectrum which is relatively similar to that illustrated in FIG. 4 and which exhibits a much broader frequency distribution compared to a uniform structuring/texturing.

FIG. 6 shows a further embodiment of a tooth arrangement according to the invention which recurs after 200 μm rolling distance of the small glass cutting wheel. Assuming the average tooth length Z′ (here 20 μm) and the average intermediate tooth space length S′ (here 30 μm) the tooth length varies according to the functional relation Z′+Δz, Z′−Δz, Z′−Δz and Z′+Δz, the intermediate tooth space length S′ according to S′, S′−Δs, S′, S′+Δs. In this case Δz is 3 μm (i.e. the fluctuation around the average value is ±15%), Δs is 6 μm (i.e. the fluctuation around the average value is ±20%). Accordingly, the deviations Δz and Δs of a tooth arrangement can generally be relatively and/or absolutely different from each other. Therefore, both the tooth lengths and the intermediate tooth space lengths have the same period length and roll off by 200 μm after four teeth or four intermediate tooth spaces respectively; however the relative changes are independent from each other and follow different functional relations. For instance, two successive teeth respectively have the same tooth lengths; the lengths of the intermediate tooth spaces of respective successive intermediate tooth spaces are respectively different from each other.

According to FIG. 6 (right) a spatial frequency spectrum is obtained which has an even broader spatial frequency distribution than the spectrums according to the FIGS. 4 and 5; accordingly, additional peaks are generated also at further intermediate parameters of the spatial frequencies. All in all, this leads to an increased oscillation excitation of the scored glass body and thus to a more uniform and more dense introduction of deep fissures along the scoring line.

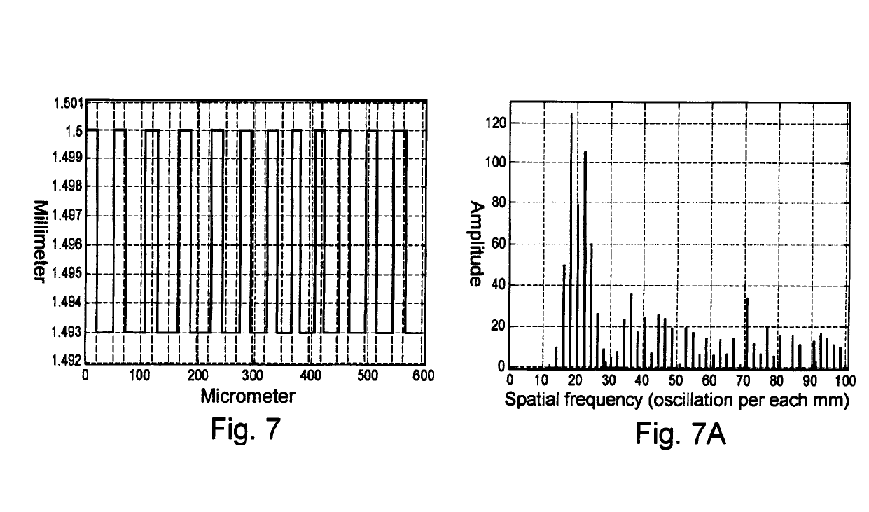

FIG. 7 illustrates a further structuring/texturing of a small cutting wheel in accordance with the invention, which cutting wheel has a recurring tooth arrangement which comprises 10 teeth and which has a length of approximately 500 μm during the rolling off movement of the wheel. The tooth length Z (approx 20 μm) as well as the intermediate tooth space length S (approx 30 μm) respectively uniformly increase towards a maximum, in order to thereafter uniformly decrease towards a minimum and then respectively increase again to the original value in the manner of a sine function. The variation of the teeth and the tooth gaps thus follows the same periodical function at a same period length. In the initial part as well as in the central part of the tooth arrangement the teeth and the intermediate tooth spaces thus have approximately the average length L′, S′ of the same. Here the maximum deviation from the average value is for Δz (approx 3 μm, approx 15%), for Δs (approx 5 μm, approx 18%). In FIG. 7 (left) the positions of the teeth at a uniform structure are illustrated in addition to the tooth arrangement in which the teeth and intermediate tooth spaces respectively have the average length. Accordingly, in the central part of the tooth arrangement and with the structure according to the invention teeth are provided in places where normally tooth gaps would be provided in a regular structuring.

It shall be understood that if necessary the lengths Z, S of the teeth and the intermediate tooth spaces can also vary according to different periodical functions, for instance the tooth lengths corresponding to a sine function and the intermediate tooth space lengths corresponding to a cosine function or a −sine function. It shall be understood that such a periodical function can be easily transferred also to recurring tooth arrangements having a different period length or a different number of teeth.

FIG. 7 (right) shows the associated spatial frequency spectrum, wherein it will be noticed that high amplitudes are generated in a broad frequency range with a plurality of different frequencies which are separated by frequency ranges of relatively low amplitudes, so that the envelope shows a certain wavy structure. Here, too a broad spatial frequency distribution is obtained with a plurality of different spatial frequencies in an illustrated frequency range, so that even under consideration of the displacement speed a broad distribution of the oscillation frequencies introduced into the glass body is obtained, which fact is very advantageous. On the other hand, sharp peaks exist in the respective spatial frequencies, which peaks are advantageous for certain cases of application.

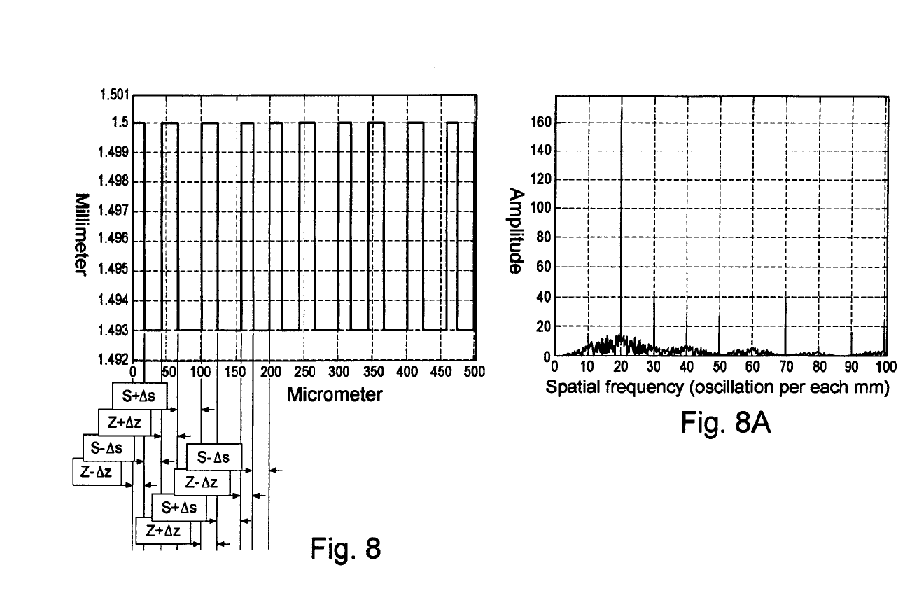

Further, it shall be understood that if necessary also the recurring tooth arrangements can be modeled or varied by a regularly or periodically selected variation parameter. So the succession of sine/cosine functions in successive tooth arrangements can be varied by the variation parameter, which can change in turn according to a mathematical-functional relation or also stochastically, hence completely randomly. Accordingly, over the given period tooth arrangements in which the tooth length and/or intermediate tooth space length follows after a sine or cosine function (or also −sine function) can be completely undetermined, whereby random successions of tooth arrangements over the tooth perimeter can be obtained. The (spatial) frequency spectrums can thus be further varied, however a certain “near structure” exists with respect to the local variations of the tooth structure. This can correspondingly apply also to variation parameters in the form of phase shifts in the tooth successions, scaling factors of the tooth lengths and/or intermediate tooth space lengths. FIG. 8 for instance shows a variation of the tooth arrangement according to FIG. 3 with a length of the arrangement of 100 μm, with equal average lengths Z′ and S′ of the teeth and the intermediate tooth spaces, wherein however the respective tooth arrangement begins completely randomly with a narrow tooth (Z′−Δz) or a broad tooth (Z′+Δz).

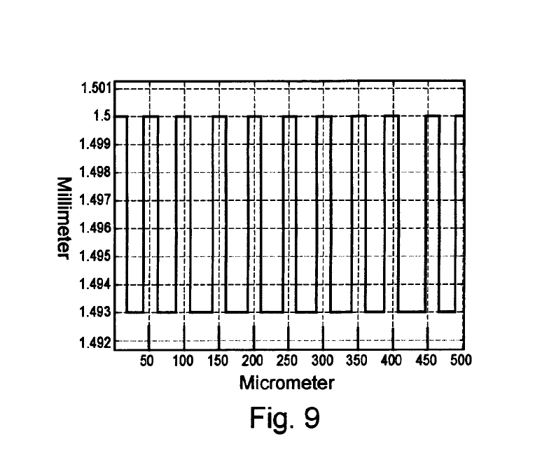

FIG. 9 shows schematically a tooth arrangement with teeth of the same length Z. The teeth are respectively offset with the centers thereof at an interval of ±d around their central position (shown by streaks on the lower line) along the circumference of the wheel. The offset is random or stochastic, and it can of course follow a mathematical function. The interval here corresponds to a maximum offset in both directions of ±Δs around the central position. The central positions are arranged at equally large steps, with a distance to each other which corresponds to the “pitch length”, i.e. the sum of the average tooth length and the average intermediate tooth space length. The resulting tooth gaps accordingly have different lengths S, wherein S is equal to S′±Δs. Alternatively, with the same intermediate tooth space length S, the intermediate tooth spaces can be offset from their central position by an interval of ±e, which fact results in teeth having a different length Z, where Z is equal to Z′±Δz. This correspondingly applies also to the arrangement of the intermediate tooth spaces which in the arrangement also fluctuate around their central position irregularly or stochastically at an interval of ±e, wherein also the central positions of the teeth are respectively arranged in a fixed sequence of steps, that is to say the pitch length.

Further, it shall be understood that a small cutting wheel can also comprise a tooth sequence which results from a succession of the structures illustrated in the FIGS. 4, 5, 6. For better understanding reference is made to FIG. 10 which is a schematic representation of a small cutting wheel having a given, recurring tooth arrangement Z1 with a period length of e.g. 400 μm. The entire circumference of the wheel can be structured/textured by the recurring tooth arrangement Z1.

FIG. 11 shows a small wheel comprising two sets of different tooth arrangements which can differ in their tooth structure/texture, e.g. tooth arrangements according to the FIGS. 4 to 6. Here the tooth arrangements Z1, Z2 can have the same or a different length or period. Also, the tooth succession Z2 can be a reversal or variation of the tooth succession Z1, for instance Z1 a tooth succession according to FIG. 7 (sine function) and tooth succession Z2 a cosine function or −sine function, so that a phase shift exists or the lengths of the teeth or intermediate tooth spaces increase first instead of decreasing. It shall be understood that the tooth arrangements can succeed each other orderly, e.g. in an alternating fashion, or stochastically, i.e. in a completely random sequence. Further, recurring tooth arrangements of a first and second set (e.g. those according to the FIGS. 4 and 5) which succeed each other regularly, e.g. in an alternating fashion, can be interrupted by tooth arrangements of further sets Z3 (see FIG. 12) or also Z4 and so on (e.g. according to the FIGS. 6, 7), which can again take place regularly according to certain mathematical functions or completely stochastically. The tooth arrangements Z1, Z2, Z3 have different lengths.

FIG. 13 shows in a strongly schematic representation a cutting machine 50 with a table 51 for supporting a glass plate 100 to be scored and with a cutting head 52 for receiving a cutting wheel 53. The cutting head 52 can be moved from a rest position 54 in which it is spaced from the glass plate to a working position 55 in which the cutting wheel is applied against the glass plate under the exertion of a contacting pressure force. Further, means 56 are provided for the adjustment of the contact pressure of the cutting wheel against the glass plate. The cutting machine includes a guide means 57, so that the cutting head 52 together with the cutting wheel 53 can be guided along a line for scoring the glass plate. The cutting wheels can represent small cutting wheels according to the invention, e.g. those according to the embodiments. The glass plate or the glass body in general can represent flat and/or curved portions 106, e.g. hollow glass portions. The glass plate can have a thickness of 0.6 mm. The cutting wheel can include recurring tooth arrangements with a circumferential length of 200-400 μm. By means of the small wheel according to the invention also glass plates having a thickness of ≧1.5 mm can be produced so as to include deep fissures which extend over the entire thickness of the glass plate and which exhibit excellent breaking edges, by applying a sufficient contact pressing force.

1. A small cutting wheel for producing a scribed predetermined breaking line, said small cutting wheel comprising a radial peripheral line defining an outer periphery of the small wheel, which peripheral line at least partially presents a cutting edge with cutting teeth which form a rough tooth system and which are circumferentially spaced from each other by intermediate tooth spaces, wherein the cutting teeth of the rough tooth system are in a non-uniform arrangement over at least a part of the circumference of the small wheel, wherein the length Z of the cutting teeth and/or the length S of the intermediate tooth spaces vary at least between some of the adjacent teeth and/or intermediate tooth spaces or between all teeth of the tooth arrangement.

2. A small wheel according to claim 1, wherein in a given non-uniform tooth arrangement with an average tooth length Z′, teeth having tooth lengths of Z′±n Δz are provided, wherein n is an integer or a rational number smaller than 1 and Δz is a deviation from the average tooth length Z′.

3. A small wheel according to claim 2, wherein the length of the intermediate tooth space S is at least mainly constant or that Δs<Δz is true for deviations Δs of the length of the intermediate tooth space S from the average length of the intermediate tooth space S′.

4. A small wheel according to claim 1, wherein in a given non-uniform tooth arrangement with an average length of the intermediate tooth space S′, intermediate tooth spaces having lengths of S′±Δs are provided, wherein n is an integer or a rational number smaller than 1 and Δs is a deviation from the average length of the intermediate tooth space S′.

5. A small wheel according to claim 4, wherein the tooth length Z is at least mainly constant or that Δz<Δs is true for the deviation Δz of the tooth length from the average tooth length Z′.

6. A small wheel according to claim 1, wherein in a given non-uniform tooth arrangement plural sets of teeth having lengths Z1, Zn and/or plural sets of intermediate tooth spaces having lengths S1, Sn are provided, wherein the teeth and/or intermediate tooth spaces of the various sets succeed each other regularly or irregularly along the rolling movement of the small wheel.

7. A small wheel according to claim 1, wherein the teeth of the non-uniform arrangement, which may have the same length Z, are displaced with the centers thereof at an interval ±d about their middle position along the circumference of the small wheel and/or that the intermediate tooth spaces, which may have the same length S, are displaced with the centers thereof at an interval ±e about their middle position along the circumference of the small wheel.

8. A small wheel according to claim 1, wherein the variation of the length of the teeth and/or the intermediate tooth spaces takes place in the sequence of the rolling movement of the small wheel according to a mathematical-functional relation.

9. A small wheel according to claim 1, wherein a reversal of the direction of displacement of the teeth and/or the intermediate tooth spaces from their middle position takes place regularly at every second to tenth tooth.

10. A small wheel according to claim 1, wherein the variation of the length of the teeth and/or intermediate tooth spaces along the rolling movement of the small wheel takes place uniformly increasing or decreasing towards the respective maximum or minimum of the tooth length and/or the length of the intermediate tooth space.

11. A small wheel according to claim 1, wherein the variation of the length of the teeth and/or the intermediate tooth spaces along the rolling movement of the small wheel takes place irregularly, inclusively stochastically.

12. A small wheel according to claim 1, wherein in the given non-uniform tooth arrangement with an average tooth length Z′ and an average length of the intermediate tooth space S′, the teeth and/or intermediate tooth spaces respectively vary about their middle position irregularly, in particular stochastically within a length interval ±d and/or ±e, wherein d<1/2 Z and e<1/2 S.

13. A small wheel according to claim 1, wherein the variation of the length of the teeth and the length of the intermediate tooth spaces along the rolling movement of the small wheel takes place according to different period sequences or according to different period lengths or periodically on one side or aperiodically on the other side.

14. A small wheel according to claim 1, wherein the tooth arrangement which extends over the circumference of the small wheel presents two or multiple repetitions of a given non-uniform tooth arrangement or is at least mainly comprised of it.

15. A small wheel according to claim 1, wherein plural circumferential sections of the small wheel having a stochastic tooth sequence are provided, with non-stochastic tooth sequences being provided between them.

16. A small wheel according to claim 1, wherein in a given non-uniform tooth arrangement an average tooth length Z′ and an average length of the intermediate tooth space S′ is given with S′≧Z′.

17. A small wheel according to claim 1, wherein a non-regular tooth arrangement as a basic arrangement is repeated in the form of variations multiple times over the circumference of the small wheel and that the variations are produced by the influence of at least one variation parameter on the parameter of the basic arrangement which defines the tooth arrangement.

18. A cutting machine with a table for supporting a body to be scribed, in particular a glass body, which machine comprises a cutting head for receiving a small cutting wheel, said cutting head being movable into a working position contacting the body under a contact pressure of the small cutting wheel, wherein for scribing the body said cutting head can be guided along a line, with the small cutting wheel applied against the body,
characterized in that a small cutting wheel according to claim 1 is arranged on the cutting head.

19. A cutting machine according to claim 18, wherein the distance of the rolling movement of at least one or all of the non-uniform tooth arrangements of the small wheel is within a range of or smaller than the thickness of the body to be scribed.

20. A cutting machine according to claim 18, wherein a non-uniform tooth arrangement is repeated multiple times over a rolling distance of the small wheel, which distance mainly corresponds to the thickness of the glass plate to be scribed.

21. Glass cutter with a handle and seat for a small glass cutting wheel, characterized in that the small cutting wheel is one according to claim 1.
